(19) United States
(12) Patent Application Publication
(10) Pub. No.: US 2011/0075802 A1
(43) Pub. Date: Mar. 31, 2011

(54) FIELD EMISSION X-RAY SOURCE WITH MAGNETIC FOCAL SPOT SCREENING

(76) Inventors: Moritz Beckmann, Cary, NC (US); Jens Fuerst, Herzogenaurach (DE); Peter Schardt, Hoechstadt (DE); Frank Sprenger, Cary, NC (US); Otto Zhou, Chapel Hill, NC (US)

(21) Appl. No.: 12/568,703

(22) Filed: Sep. 29, 2009

(51) Int. Cl. G01N 23/083; H01J 35/30; H01J 35/06

(52) U.S. Cl. 378/62; 378/137; 378/134

(57) ABSTRACT

An x-ray imaging system has an x-ray source having an electron field emission source that emits an x-ray beam that strikes an elongated, stationary anode in an evacuated housing. A magnetic deflection system steers the electron beam between the electron field emission source and the anode, so that the electron beam can strike the anode at different locations, thereby causing x-rays to be emitted from those different locations, by controlling the degree of magnetic deflection. A radiation detector detects the x-rays after attenuation by an examination subject, and generates signals dependent on the detected radiation that represent an image of the subject.

### BACKGROUND OF THE INVENTION

1. Field of the Invention

The present invention concerns an x-ray source of the type suitable for x-ray imaging, and in particular a field emission x-ray source.

2. Description of the Prior Art

X-ray imaging is widely used in many areas of medical diagnostics and treatment, as well as for industrial inspection and testing, and for security screening. For x-ray imaging that produces a three-dimensional image of the examination subject or object, the subject is irradiated with an x-ray beam from a large number of different directions, each directional radiation resulting in a 2D projection that is detected by the radiation detector. Many known techniques exist to combine the multiple 2D projections to reconstruct a 3D image of the irradiated object therefrom.

An exemplary x-ray imaging system of the above type is a computed tomography (CT) system. CT enables the reconstruction of a 3D image of the object by acquiring hundreds or thousands of 2D projections from different projection angles. In many current CT scanners, a single x-ray tube is mechanically rotated around the object in order to obtain the multiple projection data sets required for reconstructing the 3D image of the object. The need for mechanical rotation of the x-ray tube limits the rate of data acquisition. Moreover, the control of such systems is complicated by the structure for mechanically rotating the x-ray tube. Many current CT scanners acquire 2D projection images from one viewing angle at a time, and therefore the speed of the CT scanner is limited.

X-ray systems that have improved imaging speed include ultra-fast electron beam CT scanner systems and printed circuit board (PCB) inspection systems. In these known systems, an electromagnetic field steers an electron beam to different positions on the x-ray target (anode) in order to produce a scanning x-ray beam. Such systems can be large, expensive, and have a limited range of viewing angles. X-ray imaging systems that are less expensive and that provide a wider range of viewing angles are desirable.

In conventional CT systems, an x-ray tube, an x-ray detector and other equipment, such as cooling equipment, are rotated on a gantry around the examination subject. Typically, more than one thousand 2D projections are necessary for reconstructing a cross-section of a human body. Gantry speeds can be on the order of 3 Hz. This means that all components within the rotating part of the gantry experience an acceleration of approximately 30 G. All components within the gantry must be able to withstand this very large force, thereby making the overall system expensive due to the necessary structural reinforcement and mounting that is necessary. Moreover, the time for obtaining the total image is restricted by the mechanical movement of the gantry. For resolving relatively rapid movements, such as to obtain an image of a beating heart, the rotating gantry technology has reached its limits.

Several approaches are proposed to avoid the use of such a rotating gantry. Such static CT systems do not include a rotating part on which the x-ray tube, the detector and other components are mounted.

For example, U.S. Pat. No. 7,295,651 discloses a system having several sources respectively formed by field emitters, and detectors that are oriented in a ring. The x-ray emitters generate an electron flux that strikes the anode, from which x-rays are emitted. U.S. Pat. Nos. 7,218,700 and 7,233,644 disclose similar systems.

As noted above, the number of projection data sets required for achieving the same quality as in CT systems is on the order of one thousand. This means that if the x-ray source is not rotating, more than one thousand small x-ray sources must be positioned around the examination subject. Distributed x-ray sources based on carbon nanotubes have been demonstrated to be feasible, for example, as described in Applied Physics Letters 86, 184104 (2005), Zhang et al. Additionally, x-ray systems with a high number and density of individual x-ray sources are commercially available from XinRay Systems LLC. Such systems, however, require a large evacuated housing or chamber with a large number of sources therein, and are thus expensive to manufacture.

U.S. Pat. No. 7,218,700 discloses an x-ray system in order to reduce the number of x-ray sources, wherein several distinct x-ray beams are deflected by electromagnetic fields onto a ring anode. Each source generates a sweeping electron beam on this ring anode within a distinct region of the ring anode.

### SUMMARY OF THE INVENTION

It is an object of the present invention to provide an x-ray imaging system wherein the above-discussed problems associated with known systems are avoided, or at least minimized.

This object is achieved in accordance with the present invention by an x-ray source having one or more field emission electron emitters and an elongated anode structure. A magnetic field is used to deflect the electron beam or beams emitted by the emitter or emitters along the anode, so as to move the focal spot, from which the x-rays are emitted from the anode, along the elongated anode.

### BRIEF DESCRIPTION OF THE DRAWINGS

FIG. 1 schematically illustrates the use of electron sources in accordance with the present invention in a computed tomography (CT) apparatus.

FIG. 2 schematically illustrates a cathode assembly of an x-ray source in accordance with the present invention.

FIG. 3 schematically illustrates an x-ray source in accordance with the present invention.

FIG. 4 is a schematic plan view of the x-ray source of FIG. 3.

FIG. 5 shows an exemplary embodiment of a current profile for supply to the electron deflection coil in accordance with the present invention.

### DESCRIPTION OF THE PREFERRED EMBODIMENTS

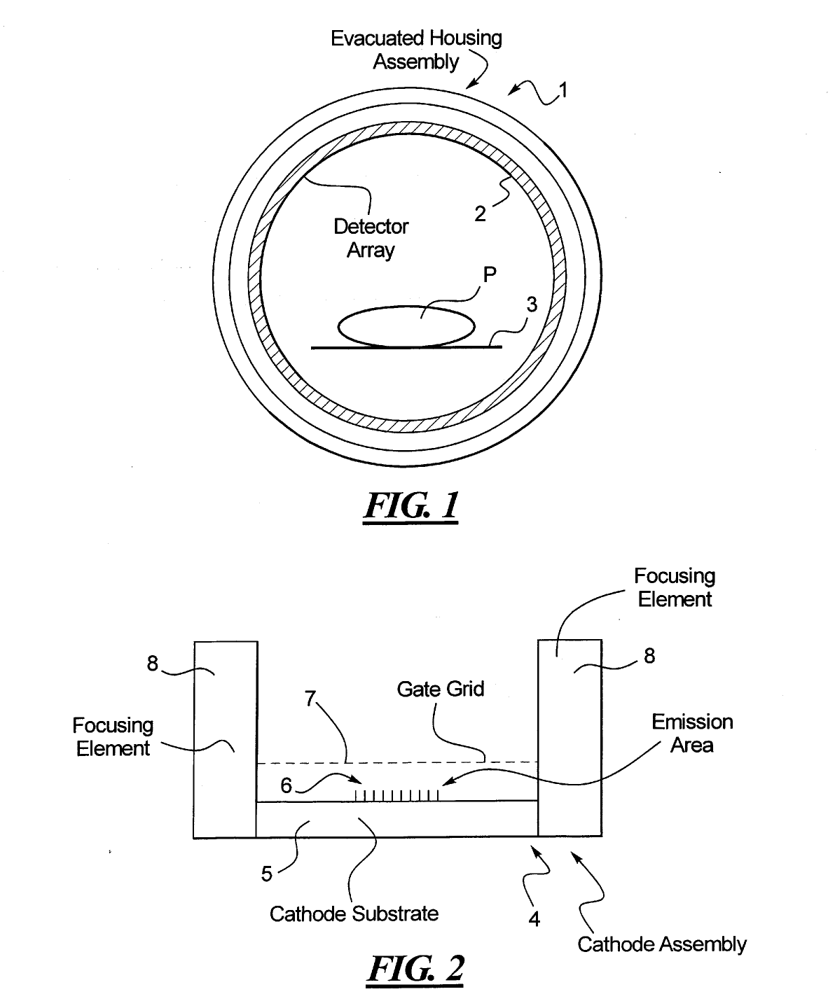

FIG. 1 schematically illustrates the use of multiple x-ray sources in accordance with the present invention in the embodiment of a computed tomography imaging apparatus. The imaging apparatus has an annular or ring-shaped evacuated housing assembly 1 which is composed of multiple x-ray sources in accordance with the present invention. The embodiment of the CT apparatus shown in FIG. 1 has a detector array ring 2 that detects the x-rays emitted from the evacuated housing assembly 1. The detector array ring 2 is offset in the longitudinal direction (i.e., the direction proceeding perpendicular to the plane of the drawing in FIG. 1) so that the x-rays emitted from the evacuated housing assembly 1 penetrate a patient P on a patient bed 3, and are then detected by individual detector elements of the detector array ring 2. The detector array ring 2, however, need not proceed continuously around the patient P, but may only occupy a portion of the total extent around the patient P, as needed.

An exemplary embodiment of a cathode assembly for suitable for use in the present invention is shown in FIG. 2. The cathode assembly 4 has a field emitter formed by a cathode substrate 5 and a gate grid 7. The gate grid 7 proceeds parallel to an emission area 6. By the application of voltage to the gate grid 7, electrons are caused to be emitted by the cathode substrate in a known manner. These electrons are focused into an electron beam by focusing elements 8. The gate grid 2 and the substrate 1 have a potential difference therebetween that causes an electric field to be generated in the emission area 6, at which the electrons are thereby caused to be emitted.

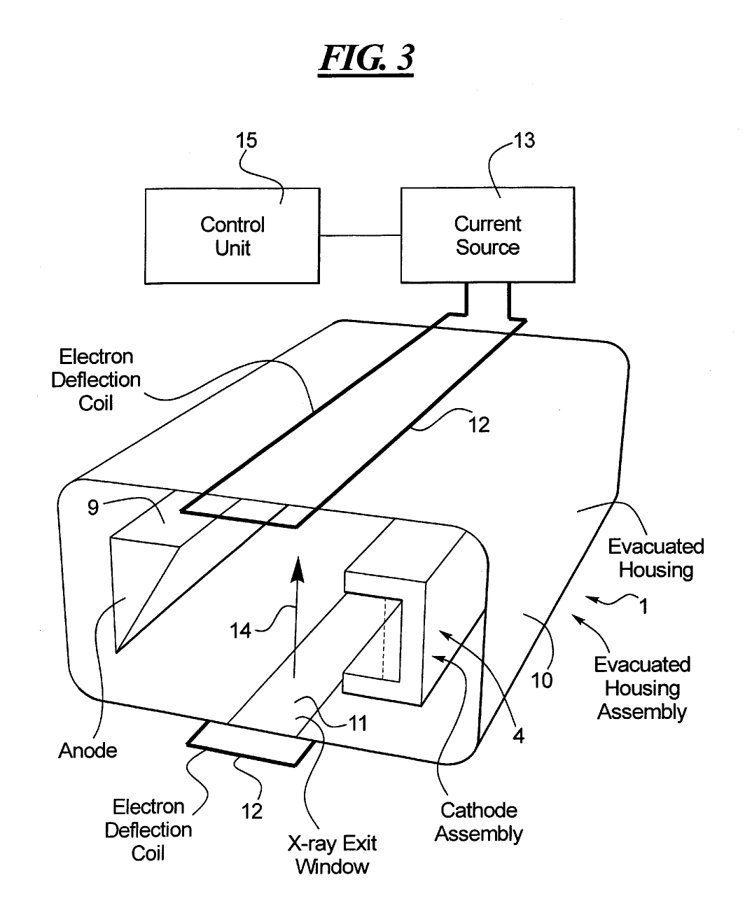

FIG. 3 shows the cathode assembly 4 in the interior of an evacuated housing 10. Opposite the cathode assembly 4 is an anode 9. By applying a high voltage between the cathode substrate 5 and the anode 9, the electrons in the aforementioned electron beam are accelerated toward the anode, and produce x-rays upon striking the anode at a focal spot. The emitted radiation exits the evacuated housing 10 via an x-ray window 12. The evacuated housing 10 of the evacuated housing assembly 1 can contain multiple cathode assemblies 4 within a certain distance. The anode 9, however, is a common anode for all cathode assemblies in the evacuated housing assembly 1.

On opposite sides of the evacuated housing 10 are coils 12, such as saddle coils. The current in the coils 12 flows in the same direction, so as to produce a magnetic field 14 perpendicular to the planes of the coils 12, as indicated by the direction of the arrowhead. The current in the coils 12 is generated by a current source 13, which is controlled in terms of amplitude and waveform by a control unit 15. The electron beam emitted by each cathode assembly 4 is deflected by the magnetic field 14, so as to strike the anode 9 at different locations, as explained in more detail in connection with FIG. 3. Each location at which the electron beam strikes the anode 9 is considered as a focal spot, so x-rays are generated from different focal spots along the length of the anode 9, depending on the amplitude of the current in the coils 12.

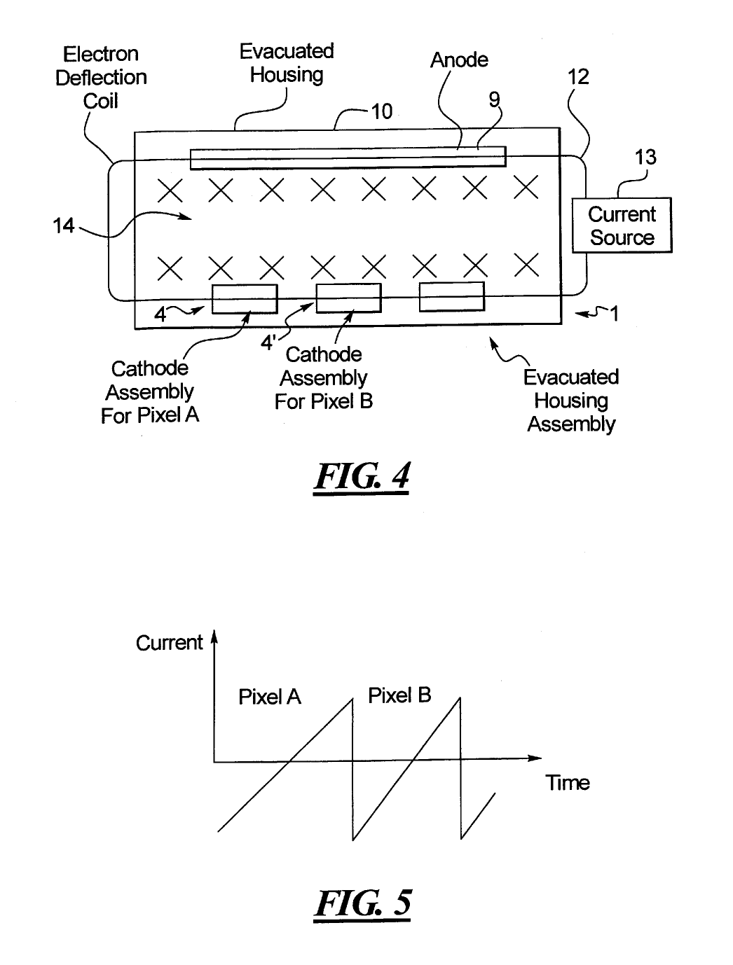

As shown in FIG. 4, multiple cathode assemblies 4 and 4′ can be provided in the evacuated housing assembly 1. This allows x-rays to be generated from a longer section of the anode 9 by steering the electron beams from the respective cathode assemblies 4 and 4′ from one side of the anode 9 to the other. Switching off the electron beam in the cathode assembly 4 and switching the electron beam on for the further cathode assembly 4′ in immediate succession can be accomplished in synchronism with the waveform (amplitude) of the current in the coils 12. An example is the use of a sawtooth waveform as shown in FIG. 5, so that the current in the coils 12 is changed back to the value that the current had at the start of a steering procedure in the cathode assembly 5, followed by starting a second steering procedure along a different anode section for the cathode assembly 4′.

For making the necessary electrical connections, the evacuated housing 10 is equipped with appropriate electrical feedthroughs for each cathode assembly 4 and 4′ (if present), and for the anode 9. These electrical connections can proceed in a known manner, and are not separately shown. The anode 9 may also be segmented in order to produce x-rays with different energies, by applying different anode voltages to the individual segments.

Additionally, a solenoid coil (not shown) can be applied along the length of the anode 9 around the evacuated housing 10, so as to produce a magnetic field along the direction of the anode 9. This allows the electron beam to be moved up and down along the anode angle of the anode 9. By changing the current in the solenoid at a high frequency, the focal spot position on the anode 9 can be changed with a high frequency perpendicular to the anode direction.

The x-ray tube described above can be designed to form a complete ring or a polygon around the examination subject. Together with all of the necessary electrical power supplies to provide the electronic extraction voltage and the anode voltage, plus the detector 2, an imaging system is achieved. The detector can be stationary or movable. The imaging system can be used for computed tomography. The scanning speed of such a system can be much higher than in conventional systems, because there are no mechanical parts of fewer mechanical parts that need to be rotated at high speeds.

Although modifications and changes may be suggested by those skilled in the art, it is the intention of the inventors to embody within the patent warranted hereon all changes and modifications as reasonably and properly come within the scope of their contribution to the art.

We claim as our invention:

1. An x-ray imaging system comprising:
an x-ray source comprising an electron field emission source and an elongated stationary anode inside an evacuated housing, said electron field emission source emitting an electron beam that is accelerated toward said anode and that, upon striking said anode, causes emission of x-rays from the anode;
a magnetic deflection system that steers the electron beam between the electron field emission source and the anode to change a location at which the x-ray beam strikes the anode and from which said x-rays are emitted; and
an x-ray detector that detects said x-rays and generates electrical signals representing an image of a subject irradiated by the x-rays.

2. An x-ray imaging system as claimed in claim 1, wherein said electron field emission source comprises an electron emitter selected from the group consisting of a nanotube, a nanorod, a Spindt tip, and diamond nanoparticles.

3. An x-ray imaging system as claimed in claim 1 wherein said electron field emission source is a first electron field emission source, and wherein said x-ray source comprises a plurality of additional electron field emission sources in addition to said first electron field emission source.

4. An x-ray imaging system as claimed in claim 1 wherein said elongated anode comprises a plurality of anode segments.

5. An x-ray imaging system as claimed in claim 1 wherein said magnetic deflection system comprises a pair of saddle coils located on an exterior of said evacuated housing.

6. An x-ray imaging system as claimed in claim 1 wherein said saddle coils are comprised of coil segments.

7. An x-ray imaging system as claimed in claim 6 wherein the respective segments of said coils are independently supplied with current.

8. An x-ray imaging system as claimed in claim 5 comprising a control unit that supplies current to said coils with a periodically changing current amplitude.

9. An x-ray imaging system as claimed in claim 8 wherein said control unit supplies current to said coils having a sawtooth waveform.

10. An x-ray imaging system as claimed in claim 1 comprising a solenoid coil proceeding around said anode along a longitudinal extent of said anode.

11. An x-ray imaging system as claimed in claim 1 wherein said electron field emission source is a first electron field emission source, and wherein said x-ray source comprises a plurality of additional electron field emission sources in addition to said first electron field emission source, and a control unit that activates said first field emission electron source and said additional field emission electron sources in succession.

12. An x-ray imaging system as claimed in claim 10 wherein said control unit operates said saddle coils simultaneously and independently of each other.

13. An x-ray imaging system as claimed in claim 1 wherein said electron field emission source is a first electron field emission source, and wherein said x-ray source comprises a plurality of additional electron field emission sources in addition to said first electron field emission source, said evacuated housing and said first electron field emission source and said additional electron field emission sources are formed as a ring surrounding said subject.

14. An x-ray imaging system as claimed in claim 1 wherein said electron field emission source is a first electron field emission source, and wherein said x-ray source comprises a plurality of additional electron field emission sources in addition to said first electron field emission source, said evacuated housing and said first electron field emission source and said additional electron field emission sources are formed as a polygon surrounding said subject.

15. An x-ray imaging system as claimed in claim 1 wherein said electron field emission source is a first electron field emission source, and wherein said x-ray source comprises a plurality of additional electron field emission sources in addition to said first electron field emission source, each of said first electron field emission source and said additional electron field emission sources being individually contained in an independent evacuated housing.

16. An x-ray imaging system as claimed in claim 1 wherein said detector comprises a plurality of detectors selected from the group consisting of Si-PIN photodiode x-ray detectors, charged coupled devices area detectors, amorphous selenium area detectors, and amorphous silicon area detectors.

17. An x-ray imaging system as claimed in claim 1 wherein said x-ray detector extends completely around said subject.

18. An x-ray imaging system as claimed in claim 1 wherein said x-ray detector is movable, and comprising a control unit that moves said x-ray detector synchronized with movement of said focal spot on said anode.
